(19) United States
(12) Patent Application Publication
(10) Pub. No.: US 2017/0249393 A1
(43) Pub. Date: Aug. 31, 2017

(54) METHOD AND BROWSER PLUGIN FOR CREATION OF OBJECTS IN A CLOUD-BASED OBJECT MANAGEMENT SYSTEM

(71) Applicant: salesforce.com, inc., San Francisco, CA (US)

(72) Inventors: Sreejesh Divakaran Nair, Tampa, FL (US); Paul David Christian, Tampa, FL (US); Tyler Clark, Tampa, FL (US); Dylan John Hansen, Vancouver (CA)

(73) Assignee: salesforce.com, inc., San Francisco, CA (US)

(21) Appl. No.: 15/055,125

(22) Filed: Feb. 26, 2016

(51) Int. Cl. G06F 17/30; G06F 17/24; G06F 3/0482; G06F 3/0481; H04L 29/08; G06F 3/0484

(52) U.S. Cl. CPC G06F 17/30873; H04L 67/02; G06F 3/04842; G06F 3/0482; G06F 3/04817; G06F 17/243

(57) ABSTRACT

Computer implemented methods and systems are provided that utilize a plugin to allow for quick creation of objects in a cloud-based object management system. The plugin interfaces with a browser application that interacts with the cloud-based object management system. To create objects at the cloud-based object management system, a user can activate the plugin and input information that is needed to create the object. Without logging into the cloud-based object management system, the plugin can then submit the information to the cloud-based object management system, which can use this information to create the object.

### TECHNICAL FIELD

Embodiments of the subject matter described herein relate generally to computer implemented methods, computer systems and applications for creating objects in a cloud-based object management system, and, more particularly, to computer implemented methods and a browser plugin for quick creation of objects in a cloud-based object management system.

### BACKGROUND

Many organizations are moving toward cloud-based services and infrastructure to provide on-demand services. Many enterprises now use cloud-based computing platforms that allow services and data to be accessed over the Internet (or via other networks). Infrastructure providers of these cloud-based computing platforms offer network-based processing systems that often support multiple enterprises (or tenants) using common computer hardware and data storage. This “cloud” computing model allows applications to be provided over the network “as a service” supplied by the infrastructure provider.

Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application feature software between multiple sets of users.

A multi-tenant system stores data as objects. Tenants may be allowed to create and store custom objects, or they may be allowed to customize standard objects, for example, by creating custom fields for standard objects. To create an object, a user must log into the system each time they desire to create a new object, and enter information that is required to create that object. This process can be time-consuming and inefficient.

### BRIEF DESCRIPTION OF THE DRAWING FIGURES

A more complete understanding of the subject matter may be derived by referring to the detailed description and claims when considered in conjunction with the following figures, wherein like reference numbers refer to similar elements throughout the figures.

FIG. 1 illustrates a block diagram of an example cloud-based environment in which the disclosed embodiments may be implemented.

FIG. 2 is a block diagram that illustrates a simplified example of system data according to an embodiment.

FIG. 3 is a schematic block diagram of a user system in accordance with an embodiment.

FIG. 4 is a flow diagram of an exemplary method for installing and configuring an object creation plugin in accordance with an embodiment.

FIG. 5 is a flow diagram of an exemplary method for using an object creation plugin to create an object in accordance with an embodiment.

FIG. 6 is a screenshot of a browser window that shows an online store for downloading applications and a pop-up window that is displayed when a user selects the object creation plugin for downloading in accordance with an embodiment.

FIG. 7A is a screenshot of a portion of a browser window that shows a plugin icon that appears in a toolbar of the browser window after the object creation plugin has been installed in accordance with an embodiment.

FIG. 7B is a screenshot of a browser window that shows a dialog box that appears for configuring the object creation plugin in accordance with an embodiment.

FIG. 7C is a screenshot of a browser window that shows the dialog box of FIG. 7B when a user enters information in some of the user input fields as the object creation plugin is being configured and a pop-up window that displays a corresponding object creation form that results in accordance with an embodiment.

FIG. 7D is a screenshot of a browser window that shows one non-limiting implementation of a pop-up window for an object creation form that is displayed within the browser window prior to other information being input in accordance with an embodiment.

FIG. 7E is a screenshot of the object creation form of FIG. 7D after the other information has been input and prior to submission to the object management system in accordance with an embodiment.

FIG. 7F is a screenshot that shows a non-limiting implementation of information that can be displayed in the object creation form within the pop-up window after submission to the object management system in accordance with an embodiment.

FIG. 8 is a screenshot of web page that displays the object generated by the object management system that in accordance with an embodiment.

FIG. 9 illustrates a block diagram of an example environment where a database service might be used, and which may be used to implement the embodiments described herein.

FIG. 10 illustrates a block diagram of another example environment, which may be used to implement the embodiments described herein.

### DETAILED DESCRIPTION

Computer implemented methods and systems are provided that utilize a plugin to allow for quick creation of objects in a cloud-based object management system. The plugin interfaces with a browser application that interacts with the cloud-based object management system. In one embodiment, a user system configures the plugin by inputting default information that is eventually used to create objects at the cloud-based object management system. After the plugin is configured with default information, and the plugin is subsequently activated, this default information can automatically be retrieved, and the plugin can prompt the user to input other information that is needed to create the object. The plugin can then use a stored session identifier to submit the default and other information to the cloud-based object management system, which can use this information to create the object.

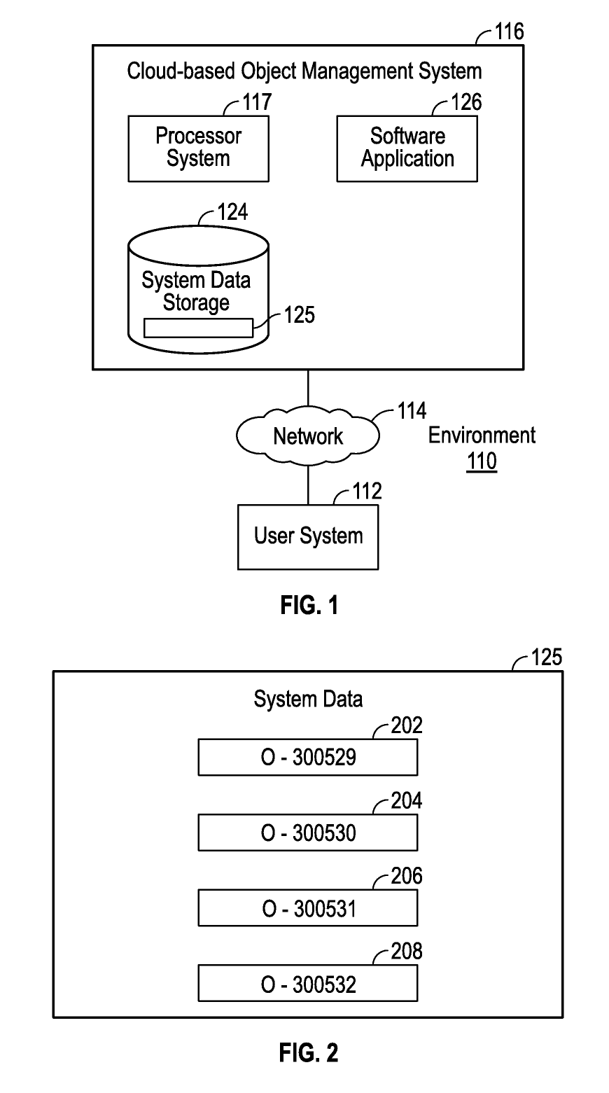

FIG. 1 illustrates a block diagram of an example cloud-based environment 110 in which the disclosed embodiments may be implemented. FIG. 1 and the following discussion are intended to provide a brief, general description of one non-limiting example of an example environment in which the embodiments described herein may be implemented. Those skilled in the art will appreciate that the embodiments described herein may be practiced with other computing environments.

Environment 110 may include user system 112, a network 114, a cloud-based object management system 116, a processor system 117, a software application 126, system data storage 124 for storing system data 125. In other embodiments, environment 110 may not have all of the components listed and/or may have other elements instead of, or in addition to, those listed above. For ease of illustration, FIG. 1 shows one block for each of user system 112, processor system 117, and system data storage 124. These blocks 112, 117, and 124 may represent multiple user systems, processor systems, and system data storage units.

In one embodiment, cloud-based object management system 116 can be an on-demand database services system that implements a cloud platform. The user system 112 is communicatively coupled to the cloud-based object management system 116 over the network 114. The cloud-based object management system 116 uses objects to store data, and enables a user (e.g., via user system 112) to interact with a cloud platform to create and manage objects that are stored within the system data storage 124 as system data 125. For example, the user system 112 can communicate information input by a user to the cloud-based object management system 116, and the processor system 117 can execute the application 126 to process this information to create objects that can then be stored in storage 124 as system data 125.

FIG. 2 is a block diagram that illustrates a simplified example of system data 125 according to an embodiment. System data 125 may be stored in system data storage 124, or may be stored in any suitable storage location. In one embodiment, system data 125 may include objects 202, 204, 206, and 208. For ease of illustration, only four objects are shown, but it will be appreciated that in a practical implementation that the system data 125 may include many thousands of objects. Furthermore, it is noted that the cloud-based object management system 116 may use any suitable naming convention to identify each object, and may generate unique identification labels for each object to prevent duplicates and to ensure consistency. For example, in the non-limiting embodiment shown in FIG. 2, objects 202-208 are also labeled O-300529, O-300530, O-300531, and O-300532, respectively, which are alphanumeric labels generated by cloud-based object management system 116 for identification purposes.

As used herein, an object can refer to a structure used to store data and associated metadata along with a globally unique identifier that allows for retrieval of the object. Objects can include standard objects and custom objects. As used herein, a standard object can refer to default objects provided by the cloud-based object management system 116. As used herein, a custom object can refer to an object that is created by the user or that customizes a standard object to extend the functionality provided by a standard object (e.g., by creating custom fields for standard objects including custom index fields). In some embodiments, custom objects can be created by a user to store information unique to their organization.

In one embodiment, each object comprises a number of fields, which correspond to columns in a database. Data is stored in records of the object, which correspond to rows in a database. Each object can include a set of different types of fields including an identity (ID) field, system fields, name fields, custom fields, and relationship fields.

The cloud-based object management system 116 can automatically assign an identity field (called ID) to every object, and manage the identity data in every object. Each object in an application can have such an identifier, and each object can be viewed by simply using a URL that includes the identity field. The cloud-based object management system 116 can automatically retrieve the objects and the associated metadata, and display that object using an automatically generated user interface.

Objects can have a number of read-only “system fields” automatically associated with them; the cloud-based object management system 116 can automatically assign values to these fields when an object is created or modified. Examples of system fields can include the ID field, discussed above, a Created Date field that indicates the date and time when the object was created, a Created By ID field that indicates the ID of the user who created the object, a Last Modified By ID field that indicates the ID of the user who last modified the object, a Last Modified Date field that indicates the date and time when the object was last modified by a user, a System Mod Stamp field that indicates the date and time when the object was last modified by a user or process, such as a trigger, etc. The name field of an object can be a text string or an auto-number field. For an auto-number field, the user can specify the format for the field and a starting number, and they increment by one each time a record is created. A custom field can be used to either extend the functionality of a standard object, or when creating new custom objects. All fields in an object can be defined as a particular data type.

Relationship fields can define relationships between data (e.g., how records in one object relate to records in another object). A relationship field can store the ID of the parent record in a relationship, as well as optionally providing user interface representations in both the parent and child records. Two types of relationship fields include lookup relationship fields and master-detail relationship fields. A lookup relationship field creates a relationship that links one object to another object to allow a user to navigate from records in one object to the related records in another object (both visually and programmatically). Lookup relationship fields can be used to create one-to-one and one-to-many relationships. By contrast, a master-detail relationship field creates a special type of relationship between two objects (the child, or “detail”) and another object (the parent, or “master”). Master-detail relationships can be used whenever there is a tight binding between two objects, and can also be used to create many-many relationships.

Objects not only provide structure for storing data, but can also power the interface elements that allow users to interact with the data, such as tabs, the layout of fields on a page, and lists of related records. Objects can also have built-in support for features such as access management, validation, formulas, triggers, labels, notes and attachments, a track field history feature, security features, etc. Attributes of an object are described with metadata, making it easy to create and modify records either through a visual interface or programmatically.

One example of an object is a work record, which is an object that helps track and log information. A work record may be associated with work that needs to be accomplished by one or more users. There are many different types of work records.

In one embodiment, the cloud-based object management system 116 may utilize a development tracking system built on the Salesforce.com platform using tools such as Visualforce and Apex, and the objects 202-208 that are stored can include work records associated with code to be integrated into the software application in order to provide changes to the software application. In this embodiment, the work records can include information regarding code changes that are to be investigated and possibly integrated into a particular release of a software application (e.g., software application 126). For instance, these work records can be associated with code that is submitted for integration into a software application, such as new functionality to be added to the software application or fixes to correct perceived errors in the code, or an investigation that is to be conducted. For example, a user story can include code for new functionality that is to be added to the software application, where a bug fix can include code that fixes a bug or problem found within the software application. The problem may be associated with the original application, a user story, or even another bug fix. An investigation can include information to be investigated (e.g., an unexpected behavior of functionality, failure of a service, etc.). It should be appreciated that these work records are just a few non-limiting examples of a types of objects that can be created by a user (via the user system 112) and stored as system 125.

In a conventional cloud-based object management system, a user (via the user system 112) logs into the cloud-based object management system 116 each time he/she desires to create a new object, such as a user story, bug fix, or investigation. The user then enters information that is required to create and properly document that new object.

This process can be time-consuming and inefficient since it often takes on the order of a minute or more each time the user creates an object. When a particular user creates many objects per day this process can consume a large part of their workday. Moreover, because the process of creating an object also interrupts the user's train of thought, it can be bothersome enough that the user may skip over the task of creating object to avoid losing track of what they are working on, but may then forget to create the object resulting in the loss of information that is potentially valuable. When a large number of users are working on joint development effort these drawbacks become even more pronounced.

To address these issues, as will be described in greater detail below, the disclosed embodiments provide computer implemented methods and a browser plugin for quick creation of objects in a cloud-based object management system.

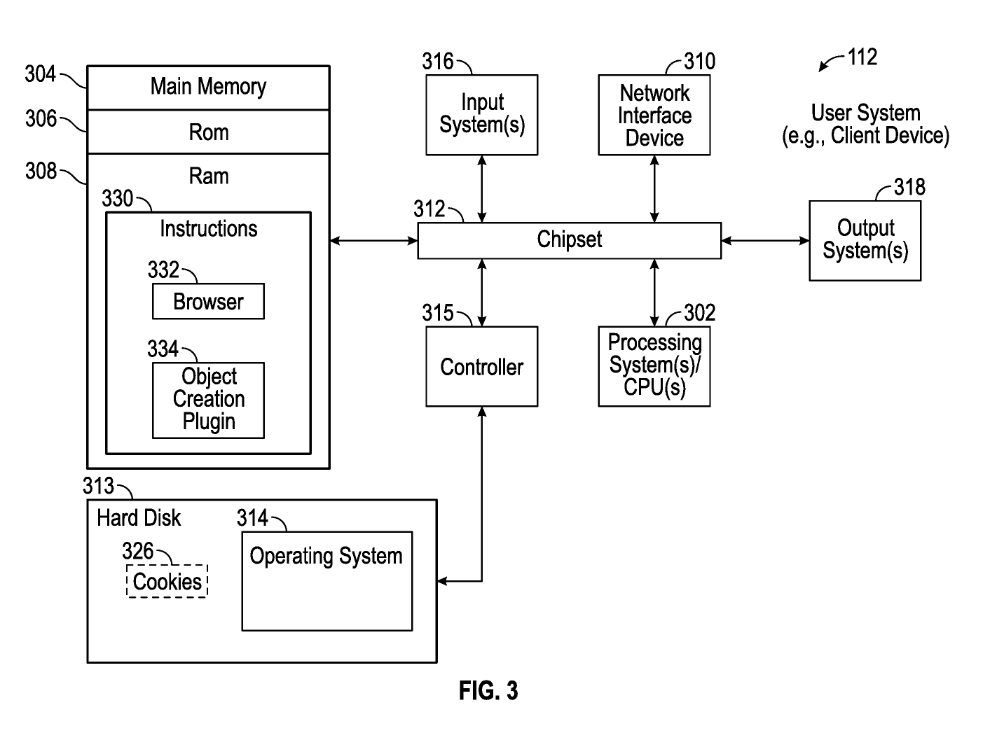

FIG. 3 is a schematic block diagram of a user system in accordance with an embodiment. FIG. 3 will be described with reference to FIG. 1. The user system 112 can include one or more processing system(s) 302, main memory 304, a network interface device (NID) 310, a chipset 312, a hard disk 313 and hard disk controller 315, input systems 316, and output systems 318. It will be appreciated that the user system 112 may not include all of the components shown in FIG. 3, may include other components that are not explicitly shown in FIG. 3, or may utilize an architecture completely different than that shown in FIG. 3.

The chipset 312 is usually located on a motherboard of the user system 112. The chipset 312 is a set of electronic components (e.g., in an integrated circuit) that interconnects and manages the data flow between the processing system(s) 302 and other elements of the user system 112 and any peripherals that are connected to the user system 112. For instance, the chipset 312 provides an interface between the processing system(s) 302 and the main memory 304, and also includes functionality for providing network connectivity through the NID 310, such as a gigabit Ethernet adapter. The chipset 312 typically contains the processor bus interface (also known as a front-side bus), memory controllers, bus controllers, I/O controllers, etc.

Processing system(s) 302 represents one or more general-purpose processing devices such as a microprocessor, central processing unit, or the like. More particularly, the processing system(s) 302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing system(s) 302 may also be one or more special-purpose processing devices such as an application specific integrated circuit (ASIC), a field programmable gate array (FPGA), a digital signal processor (DSP), network processor, or the like.

The processing system(s) 302 can include one or more central processing units (“CPUs”) that operate in conjunction with the chipset 312. The processing system(s) 302 perform arithmetic and logical operations necessary for the operation of the user system 112. The processing system(s) 302 can perform the necessary operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The NID 310 is capable of connecting the user system 112 to other computers over the network 130. The network 130 can be an Ethernet or Gigabyte Ethernet LAN, a fiber ring, a fiber star, wireless, optical, satellite, a WAN, a MAN, or any other network technology, topology, protocol, or combination thereof.

Input system(s) 316 (or input device(s)) allow the user to input information to the user system and can include things such as a keyboard, a mouse or other cursor pointing device, a pen, a voice input device, a touch input device, a webcam device, a microphone, etc. Output system(s) 218 (or output device(s)) present information to the user of the user system and can include things such as a display, monitor, speakers, or the like. All of these systems/devices are well known in the art and need not be discussed at length here.

The chipset 312 can provide an interface to various forms of computer-readable storage media including a main memory 304 (e.g., read-only memory (ROM), flash memory, dynamic random access memory (DRAM) such as synchronous DRAM (SDRAM)), and hard disk 313. The processing system(s) 302 can communicate with the various forms for computer-readable storage media via the chipset 312 and appropriate buses.

A hard disk 313 is a form of non-volatile memory that stores an operating system (OS) 314. The operating system 314 is software that is copied into RAM and executed by the processing system(s) 302 to control the operation of the user system 112, manage computer hardware and software resources, and provide common services for computer programs executed by the processing system(s) 302. Regardless of the implementation, the operating system 314 includes many different “components” that make the different parts of the user system 112 work together. The disk controller 315 is the controller circuit which enables the processing system 302 to communicate with a hard disk 313, and provides an interface between the hard disk 313 and the bus connecting it to the rest of the system. The hard disk 313 can also store cookies 326 that are used by the browser application 332 as will be described in greater detail below.

The main memory 304 may be composed of many different types of memory components. The main memory 304 can include non-volatile memory (such as read-only memory (ROM) 306, flash memory, etc.), volatile memory (such as random access memory (RAM) 308), or some combination of the two. The RAM 308 can be any type of suitable random access memory including the various types of dynamic random access memory (DRAM) such as SDRAM, the various types of static RAM (SRAM). The main memory 304 (as well as the processing system(s) 302) may be distributed throughout the user system 112.

The ROM 306 of the main memory 304 can be used to store firmware that includes program code containing the basic routines that help to start up the user system 112 and to transfer information between elements within the user system 112. The ROM of the main memory 304 may also store other software components necessary for the operation of the user system 112.

The RAM 308 stores programs/instructions 330 or executable code for one or more programs that can be loaded and executed at processing system(s) 302 to perform various functions. The programs/instructions 330 are computer readable program code that can be stored in RAM 308 (or other a non-transitory computer readable medium of the user system 112) that can be read and executed by processing system(s) 302 to perform various acts, tasks, functions, and steps as described herein. Two examples of programs/instructions 330 that are stored in the RAM 308 include a browser application 332 and an object creation plugin 334 in accordance with the embodiments described herein.

As is known in the art, the browser application 332 includes various functional modules including a user interface that includes a main window and various parts of the browser display such as the address bar, back/forward button, bookmarking menu etc., a browser engine which server as an interface for querying and manipulating one or more instances of rendering engine that is responsible for displaying the requested contents on a browser screen, a networking module used for network calls, a JavaScript Interpreter that is used to parse and execute the JavaScript code, user interface backend, a data storage or persistence layer that is used to save data, including cookies, on the hard disk, etc. When executed by the processing system(s) 302, the browser application 332 can be used for retrieving, presenting, and traversing information resources on the Internet. The browser application 332 brings information resources to the user (“retrieval” or “fetching”), allowing them to view the information (“display”, “rendering”), and then access other information (“navigation”, “following links”). An information resource is identified by a Uniform Resource Identifier (URI/URL) and may be a web page, image, video or other piece of content. Hyperlinks present in resources enable users easily to navigate to related resources.

The user system 112 can download an object creation plugin 334 from a server (or online “store”) and load it into RAM. The object creation plugin 334 interfaces with the browser application 332 via an application programming interface (API) such as a Netscape Plugin Application Programming Interface (NPAPI) or Pepper Plugin API (PPAPI) used in Google Chrome browsers.

As used herein, a “plugin” refers to a software component that adds a specific feature to an existing browser application 332. The term “plugin” is synonymous with the terms browser extension, addon or addin. The browser application 332 provides services which the plugin 334 can use including a way for the plugin 334 to register with the browser application 332 and a protocol for the exchange of data with plugin 334. The browser application 332 operates independently of the plugin 334. Functionality provided by the plugin 334 can be implemented using shared libraries installed in a place prescribed by the browser application 332.

The plugin 334 can be configured via inputs from the user system 112. In some embodiments, these inputs can include default information that is stored by the plugin 334 for future use, and eventually used by the cloud-based object management system 116 along with other information input via the user system 112 to create objects. For example, in one embodiment, after installation of the plugin, a dialog box can be presented within a browser window. The dialog box is a graphical control element, such as a temporary window, that the plugin 334 creates to prompt the user for inputs. The plugin 334 uses the dialog box (or boxes) to prompt the user for additional information. This dialog box can include various user input fields that a user of the user system 112 can input the default information into. This default information is reoccurring information that is consistently the same in various objects that the user of the user system 112 would otherwise normally create at the cloud-based object management system 116 by logging into the system 116, opening a new object template, and manually entering that information.

As will be explained in greater detail below, in accordance with some of the disclosed embodiments, the default information is defined during configuration (and prior to activating the plugin 334) so that each time the plugin 334 is subsequently activated the default information can be used to pre-populate certain fields displayed in a pop-up window to reduce amount of information that the user has to input to create objects at the cloud-based object management system 116.

Whenever the plugin 334 is activated to create objects, any default information that has been stored can automatically be included within the first set of the fields that are displayed in a pop-up window created by the plugin 334. To explain further, upon being activated and executed by the processing system, the plugin 334 can render, within a browser window, a pop-up window (not illustrated) at a display of one of the output systems 329. This pop-up window can include an object creation form that includes a first set of the fields that have been pre-populated with certain default information, and a second set of fields that are empty or unpopulated, but that are configured to have other information input into them via a user of the user system 112. After the user of the user system fills in the second set of fields with the other information, and save it, the plugin 334 can then communicate this “other information” along with the default information (if any) to the application 126 that is executing at the processing system 117 of the cloud-based object management system. The application 126 can then process this information to create an object that can be stored at the cloud-based object management system 116. In other words, the application 126 can create the object using the default information (if any) and the other information input by the user system, and then store the object as part of the system data 125.

In some implementations, it is desirable to ensure that the user system 112 has been authenticated before allowing objects to be created using the plugin 334. At the same time, it is also desirable for the object creation process to be as quick as possible for the user. To help ensure this, in one embodiment, after successful authentication and authorization with the cloud-based object management system 116 the cloud-based object management system 116 issues a session identifier (ID) to the browser application 332 that the browser application 332 can store in a a session cookie 326. This session cookie establishes that the user system has successful authenticated with the application at the cloud-based object management system 116 so long as the session cookie remains valid. As used herein, the term “session cookie” refers to a type of file (e.g., a text string) that is sent by an application to a browser application after successfully authenticating to the application. The session cookie includes information about the browser, and can include a session identifier (ID) that identifies a session from a previous login, and may optionally store login information for that user. The browser application 332 stores the session cookie for later use so that the next time a user attempts to access the application (e.g., request a page served by the application), the browser application 332 can simply send the session cookie back to the application to establish a session. In one embodiment, the session cookie is valid until it expires (when the session cookie is valid for a limited duration or specified time) or until it is deleted. In one embodiment, the session cookie is valid until a specific action occurs (e.g., browser window used to establish the session is closed).

The browser application 332 can store this session cookie 326, for example, at the hard disk 313, and the plugin 334 can then use the session identifier from the session cookie to establish a session with the application of the cloud-based object management system 116 (so long as the session cookie remains valid). For example, in one embodiment, when the plugin 334 wants to create an object, the plugin 334 can communicate a request to create the object to the cloud-based object management system 116. This request can include session identifier from the session cookie, the default information (if any) and the other information submitted from the plugin 334. If the cloud-based object management system 116 determines that the session identifier from the session cookie is no longer valid (e.g., has expired), it can deny the request and communicate a message back to the plugin to that effect. If the cloud-based object management system 116 determines that the session identifier from the session cookie is still valid (e.g., has not expired), it can implicitly grant the request by accepting the default information (if any) and the other information submitted from the plugin 334, and use this information to create the object. This helps eliminate the need for the user to login to the cloud-based object management system 116 each time the user wants to use the plugin 334 to create an object. As such, when the session identifier from the session cookie is determined to be valid by the cloud-based object management system 116, the cloud-based object management system 116 can create the object without requiring a user of the user system to manually enter information to login into and authenticate with the cloud-based object management system 116.

Once the cloud-based object management system 116 has created the object, it can communicate a response back to the plugin 334 indicating that the object was successfully created. In one embodiment, this response can include a URL to a page created by the system 116 that displays the object. This page is rendered by the application at the cloud-based object management system 116 and provides at least the information that was provided from the plugin 334 to the cloud-based object management system 116 to create the object. The plugin 334 can display a message within a pop-up window indicating that the object has been created. This message can be in the form of a hyperlink that a user can select to load the URL to navigate to the page that displays the object.

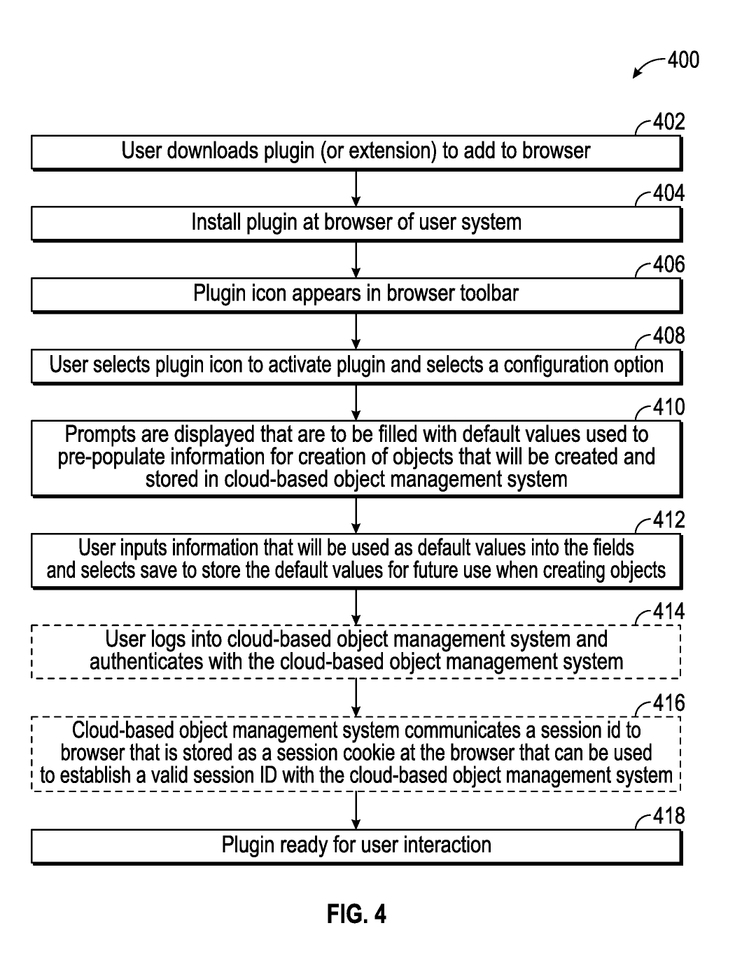

Various functions performed by the processing system(s) 302 upon loading and executing the browser application 332 and the object creation plugin 334 will be described in greater detail with reference to FIG. 4-8.

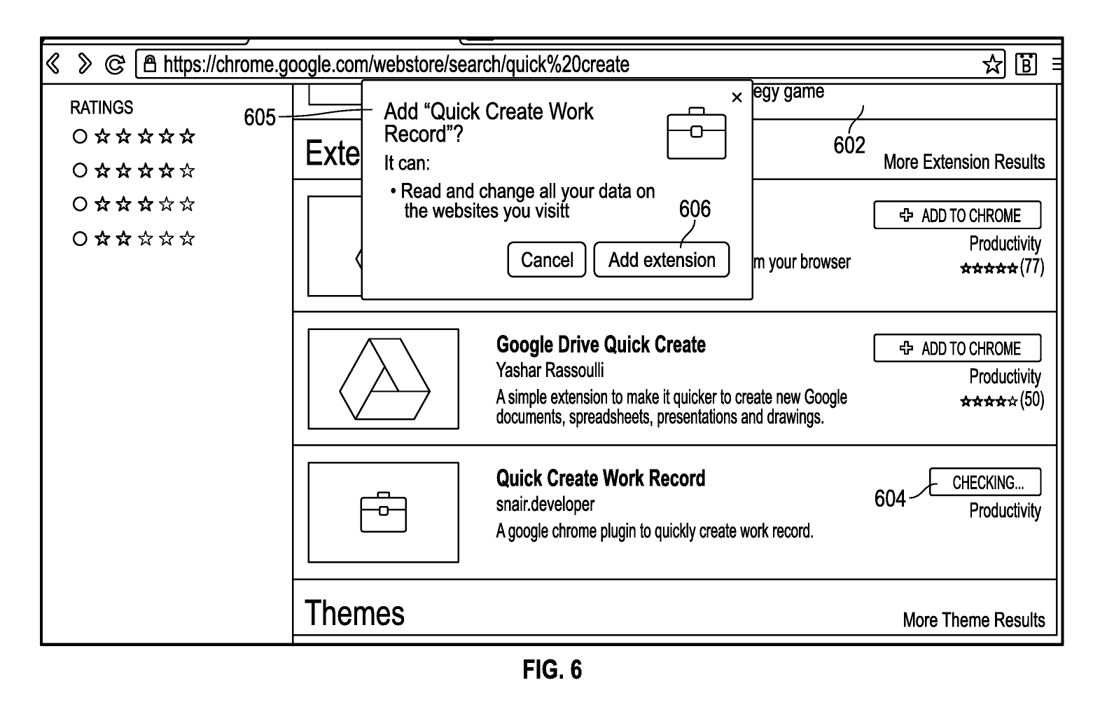

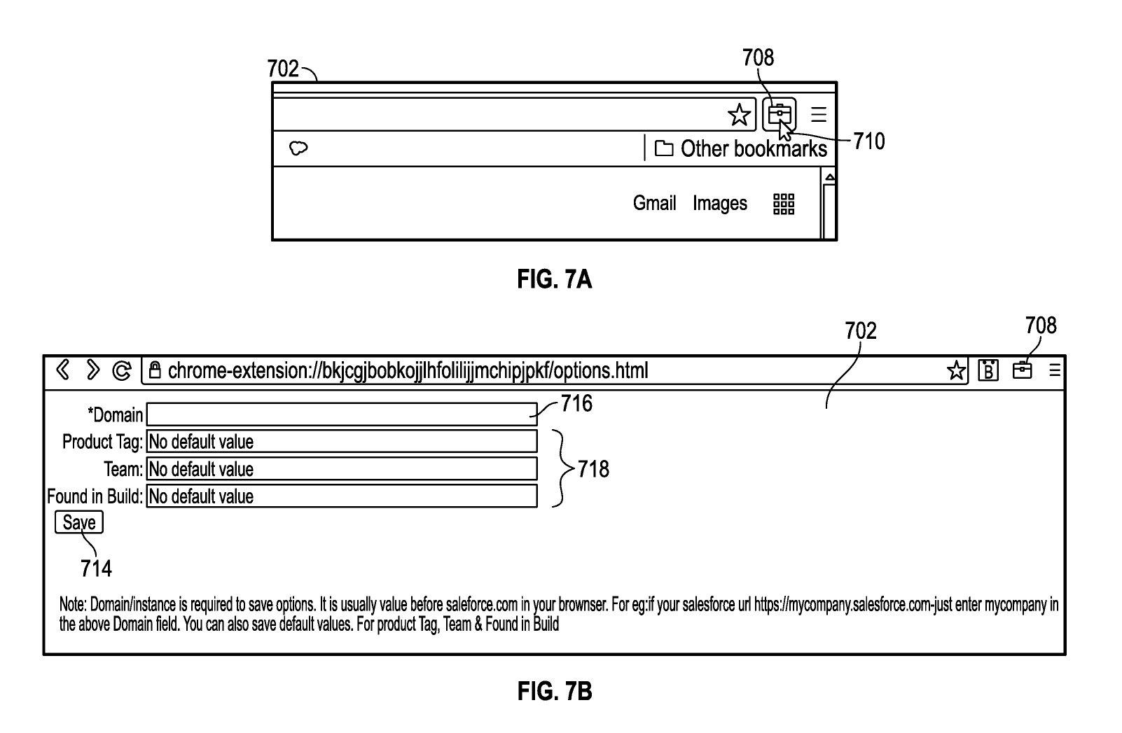

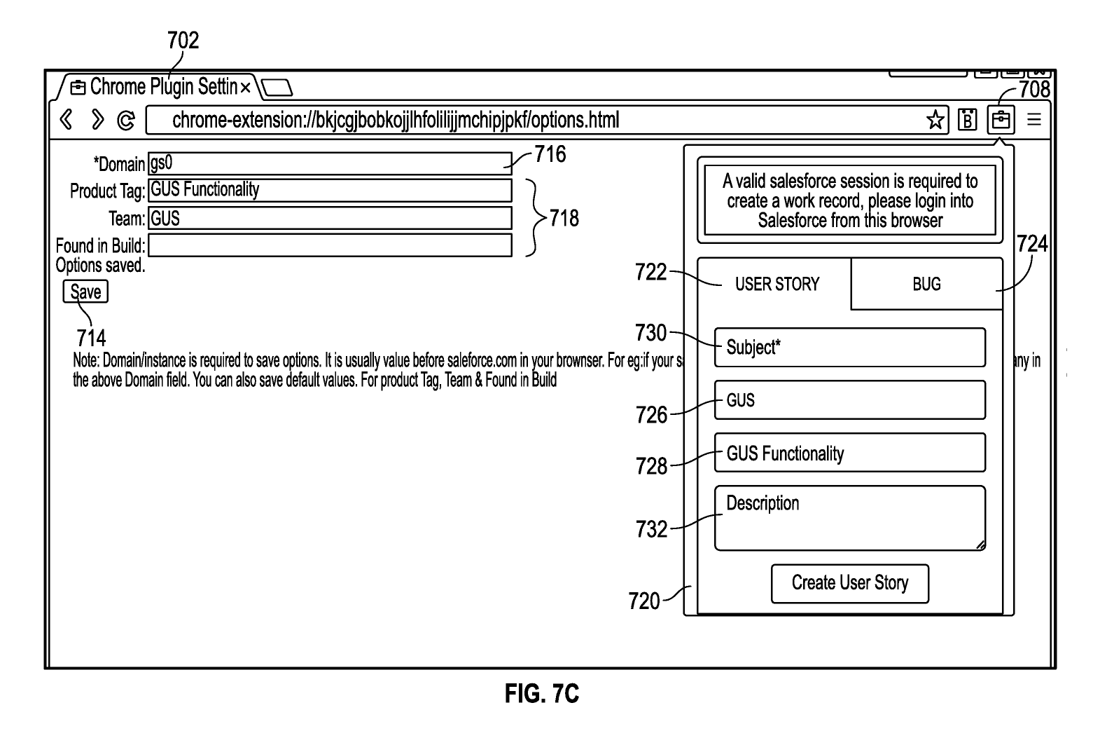

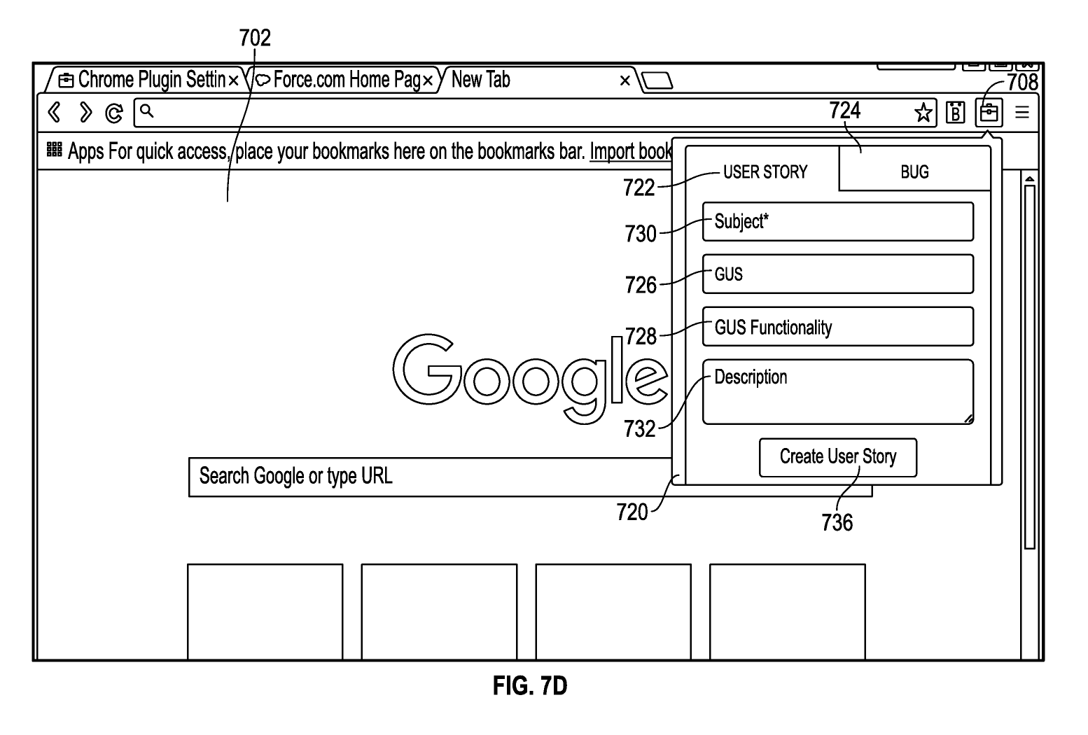

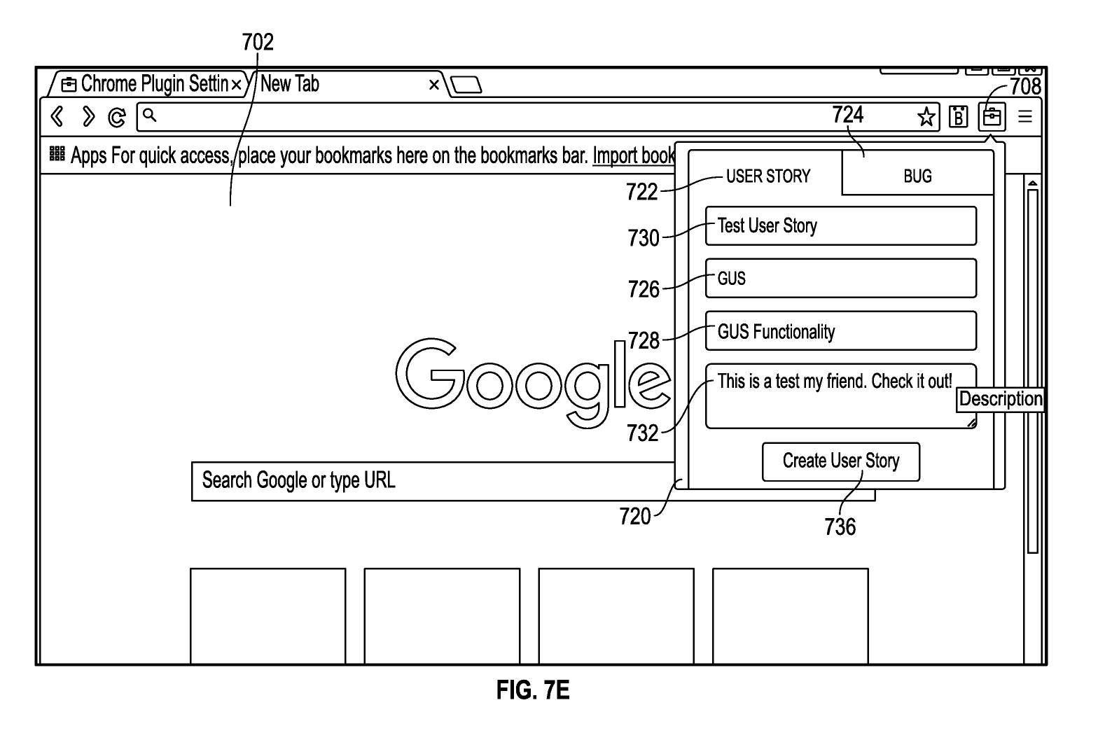

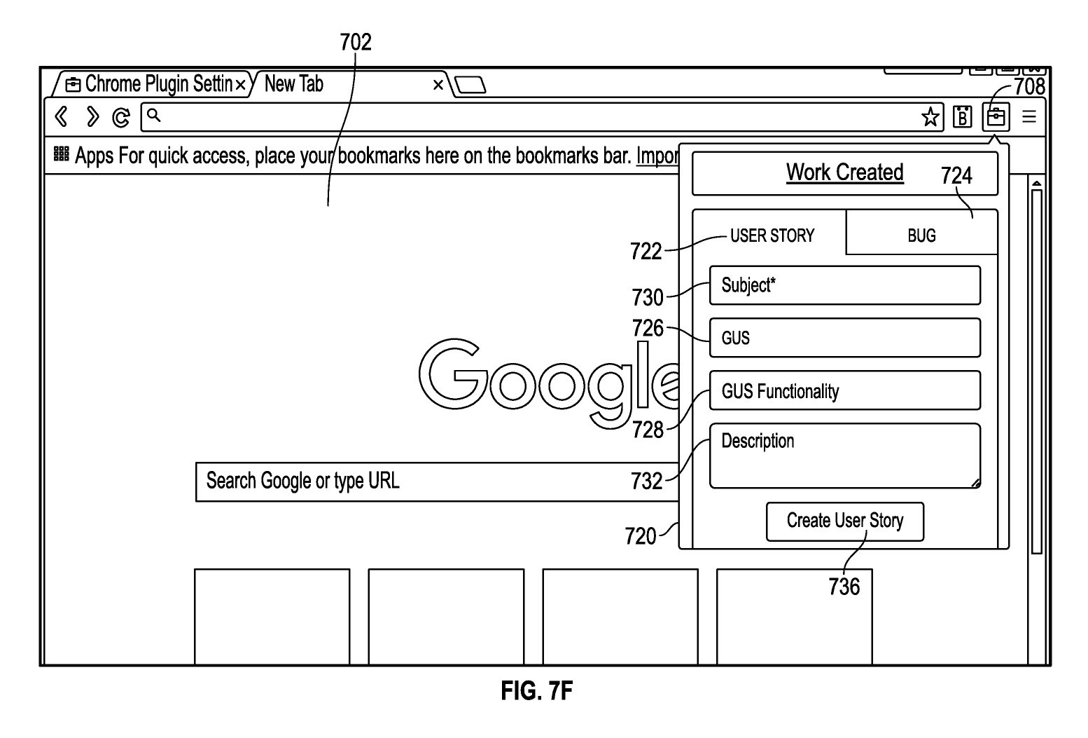

FIG. 4 is a flow diagram of an exemplary method 400 for installing and configuring an object creation plugin 334 in accordance with an embodiment. FIG. 4 will be described with reference to FIGS. 1-3 and FIGS. 6 and 7A-7C. FIGS. 6 and 7A-7C collectively illustrate one non-limiting implementation for installing an object creation plugin 334 and configuring the object creation plugin 334 in accordance with the disclosed embodiments.

As a preliminary matter, it should be understood that steps of the method 400 are not necessarily presented in any particular order and that performance of some or all the steps in an alternative order is possible and is contemplated. The steps have been presented in the demonstrated order for ease of description and illustration. Further, steps can be added, omitted, and/or performed simultaneously without departing from the scope of the appended claims. It should also be understood that the illustrated method 400 can be stopped at any time. In certain embodiments, some or all steps of this process, and/or substantially equivalent steps, are performed by execution of processor-readable instructions stored or included on a processor-readable medium, for example. For instance, in the description of FIG. 4 that follows, the user system 112 including the browser 332 and the object creation plugin 334, as well as the cloud-based object management system 116 will be described as performing various acts, tasks or steps, but it should be appreciated that this refers to the processing system(s) 302 of the user system 112 and the processor system 117 of the cloud-based object management system 116 executing instructions to perform those various acts, tasks or steps. Depending on the implementation, the processor system 117 of the cloud-based object management system 116 can be centrally located, or distributed among a number of server systems that work together. Furthermore, in the description of FIG. 4, it will be understood that any actions described as being performed by the user are performed by the user interacting with the user system 112.

At 402, the user downloads the object creation plugin 334 that is to be added to the browser 332. FIG. 6 is a screenshot of a browser window 602 that shows an online store for downloading applications and a pop-up window 605 that is displayed when a user selects the object creation plugin 334 for downloading in accordance with an embodiment. The user can use the browser to navigate to a website (e.g., Google's Chrome Web store), find a link for installing the object creation plugin 334 (e.g., Quick Create Work Record), and select an add to browser button 604, at which point a pop-up window 605 appears with a button 606 that confirms the user wants to add the object creation plugin 334. When the user confirms that the user wants to add the object creation plugin 334 (e.g., by clicking the button 606), the object creation plugin 334 starts to download to the user system 112. Once the download is complete and the object creation plugin 334 is ready for installation, at 404, the object creation plugin 334 can be installed at the browser 332 of the user system 112. The object creation plugin 334 can be installed automatically or in response to user inputs.

After the object creation plugin 334 has been installed, at 406, a plugin icon 708 appears in the toolbar of the browser 332 window. FIG. 7A is a screenshot of a portion of a browser window 702 that shows a plugin icon 708 that appears in a toolbar of the browser window 702 after the object creation plugin 334 has been installed in accordance with an embodiment. At 408, when the user selects the plugin icon 708, for example, by hovering over it with a cursor 710 and clicking it, the object creation plugin 334 is activated for the first time, and the user is presented with a configuration option that the user can select. For example, in one embodiment, the user can right click on the plugin icon 708, and an “options” link will appear that the user can use to select the configuration option.

When the user selects the configuration option at 408, a dialog box is displayed (at 410) that includes a number of user input prompts or fields 716, 718. FIG. 7B is a screenshot of a browser window 702 that shows a dialog box that appears for configuring the object creation plugin 334 in accordance with an embodiment. Some of these user input fields, such as domain field 716 of FIG. 7B are used to input identification information such as the domain, whereas others of these user input fields 718 can be filled with (or receive) default values or information input by a user of the user system. For example, in one embodiment, as shown in FIG. 7B, the user input fields 718 allow the user to input reoccurring values or other information that are consistently the same in most (or all) objects that a particular user creates, and can therefore be pre-defined so that they can later be used to create objects that can be stored in cloud-based object management system 116. As can be described below, these default values or other information are then eventually used to pre-populate some of the information needed to create objects that can be stored in cloud-based object management system 116.

At 412, the user inputs information into the user input fields 718 that can be used as the default values/information and selects save (via button 714) to store the default values/information for future use when creating objects. FIG. 7C is a screenshot of a browser window 702 that shows the dialog box of FIG. 7B when a user enters information in some of the user input fields as the object creation plugin 334 is being configured and a pop-up window that displays a corresponding object creation form 720 that results in accordance with an embodiment. After all of the information is input at 412 and successfully saved, this information can automatically be included as part of the object each time the user activates the object creation plugin 334 to create an object (assuming the user has a valid session with the cloud-based object management system 116 as can be described in greater detail below).

In the event the user is not currently logged into the cloud-based object management system 116, then at 414, the user logs into the cloud-based object management system 116 and authenticates with the cloud-based object management system 116. The login and authentication method used can vary depending on the embodiment. In one embodiment, the user enters a user name and password. In another embodiment, a single sign-on (SSO) based on federated identity can be used. Depending on the implementation, the user system 112 can successfully authenticate with the cloud-based object management system 116 by submitting a valid identifier to the cloud-based object management system 116, such as, one or more of a user name, a password, a PIN, a key, a certificate, an authentication ticket, token, a biometric sample, etc.

As part of successful authentication, at 416, the cloud-based object management system 116 communicates a session identifier to the browser 332. This session identifier is used by the user system to establish a valid session with the cloud-based object management system 116. The browser 332 stores this session identifier as a session cookie and uses it to establish a valid session ID with the cloud-based object management system 116 so long as the session identifier from the session cookie remains valid. However, it should be appreciated that 414 and 416 could take place at any point in the method 400.

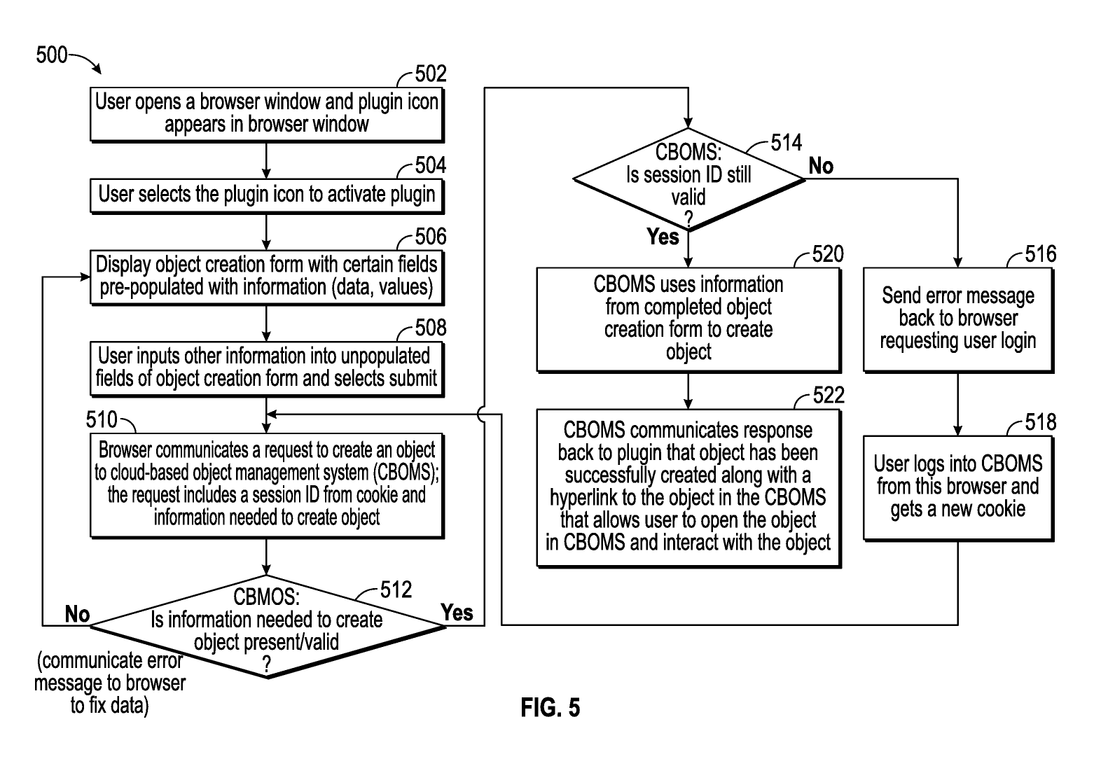

At 418, the object creation plugin 334 is ready for user interaction, and the user can quickly create objects without having to login to manually login to the cloud-based object management system 116 because the stored session ID from the session cookie can be used, and without having to manually enter all of the information needed to create the objects. Instead, certain fields of an object creation form can be pre-populated with the default values or information that are consistently the same in most (or all) objects, and used to create objects that are stored at cloud-based object management system 116. For example, as shown in FIG. 7C, the object creation form 720 can include certain fields 726, 728 that are pre-populated with default values or information. FIG. 7C can be described in greater detail below with reference to FIG. 5.

This object creation plugin 334 can save a significant amount of time since the user does not have to undergo a time-consuming log in process to the cloud-based object management system 116 to create an object at the cloud-based object management system 116. In addition, the user only needs to input some of the information that would be needed to create an object at the cloud-based object management system 116. This is a significant time-saver for an individual user, but is even more beneficial when hundreds or thousands of users, who are part of a common software development effort, can use this technology to quickly create objects. For example, in one implementation, the object creation plugin was implemented as a Google Chrome plugin that allows work records to be quickly created in Salesforce.com's Grand Unified System (GUS). As one particular example, a work record can be for a bug, user story, investigation, incident case, etc. For instance, in the case of a user story or bug fix, some of the fields that can be prepopulated with default information might be instance, product tag, team, and found in build, whereas the unpopulated fields can include things such as a subject and description. Creating work records with the object creation plugin is much faster than in comparison to the prior approach without the object creation plugin because there is no need to open a session with the GUS, fill in all of the data needed to create a work record, and then save it. For example, in comparison to the conventional approach, the time spent to create work records when using the object creation plugin was reduced by 90 percent (or more).

FIG. 5 is a flow diagram of an exemplary method 500 for using an object creation plugin 334 to create an object in accordance with an embodiment. FIG. 5 will be described with reference to FIGS. 1-4, FIGS. 7D-7F and FIG. 8. FIGS. 7D through 7F collectively illustrate one non-limiting implementation for using an object creation plugin 334 during the process of creating an object in accordance with the disclosed embodiments.

As with FIG. 5, it should be understood that steps of the method 500 in FIG. 5 are not necessarily presented in any particular order and that performance of some or all the steps in an alternative order is possible and is contemplated. The steps have been presented in the demonstrated order for ease of description and illustration. Further, steps can be added, omitted, and/or performed simultaneously without departing from the scope of the appended claims. It should also be understood that the illustrated method 500 can be stopped at any time. In certain embodiments, some or all steps of this process, and/or substantially equivalent steps, are performed by execution of processor-readable instructions stored or included on a processor-readable medium, for example. For instance, in the description of FIG. 5 that follows, the user system 112 including the browser 332 and the object creation plugin 334, as well as the cloud-based object management system 116 will be described as performing various acts, tasks or steps, but it should be appreciated that this refers to the processing system(s) 302 of the user system 112 and the processor system 117 of the cloud-based object management system 116 executing instructions to perform those various acts, tasks or steps. As in the description of FIG. 5, it will be understood that any actions described in FIG. 5 as being performed by the user are performed by the user interacting with a user system 112.

As shown in FIG. 7D, at 502, the user opens a window 722 of the browser 332 with an icon 708 for the object creation plugin 334 that appears within the window 722, and at 504, the user selects the icon 708 to activate the object creation plugin 334, and a pop-up window 720 appears that displays an object creation form 722.

At 506, the browser 332 displays the pop-up window that includes an object creation form. Certain fields of this object creation form are pre-populated with information that the user had previously entered (at 516 of FIG. 5), while other are empty and are to be filled in by the user. FIG. 7D shows an example of one non-limiting implementation of a pop-up window 720 for an object creation form that is displayed at step 506 within the browser window 702 of the browser 332. In this particular implementation, the object to be created is a work record, in particular, a user story 722. The pop-up window 720 for the user story includes an object creation form 722 with two fields 726, 728 for a team (i.e., GUS) and product tag (GUS functionality) have been pre-populated with information so that the user only needs to enter information in a subject field 730 and a description field 732 to complete information needed to create the user story 722.

At 508, the user inputs other information into the unpopulated fields of the object creation form and when the user is done inputting information, the user submits the information from the object creation form to the cloud-based object management system 116. FIG. 7E is a screenshot shows the pop-up window 720 that is displayed at step 508 within the browser window 702 of the browser 332, and in particular, the object creation form of FIG. 7D after the other information has been input and prior to submission to the object management system 116. In this particular implementation, the user inputs information (e.g., Test story) into the subject field 730 of the user story 722 and other information (e.g., Test description) into the description field 732 of the user story 722 to complete information needed to create the user story. In this example, the user selects the Create User Story icon 736 to submit the information from the completed object creation form to the cloud-based object management system 116.

When the user submits the completed object creation form at 508, the method 500 proceeds to 510, where the browser 332 communicates a request to the cloud-based object management system 116 to create an object. This request includes a session identifier from a session cookie that the browser 332 has stored, and the information from the object creation form that would be needed to create the object. In one embodiment, the session identifier from the session cookie is relatively long-lived and is valid for an extended time period (e.g., one day).

At 512, the cloud-based object management system 116 determines whether the information needed to create the object is present and valid. In some situations, the user might input information into the object creation form that is incorrect (e.g., user enters information that is not permitted into a particular field) or incomplete (e.g., user forgets to complete a field). As such, when the cloud-based object management system 116 determines (at 512) that the information needed to create the object is not present and/or invalid, the cloud-based object management system 116 communicates an error message to the browser 332 indicating that information is incomplete or invalid and the method 500 loops back to 508 where the user is prompted to input information to correct the error. The steps at 512, 508, 510 can loop until the cloud-based object management system 116 determines (at 512) that the information needed to create the object is present and valid. The method 500 then proceeds to 514.

At 514, the cloud-based object management system 116 determines whether to grant the request to create an object by determining whether the session identifier from the session cookie is still valid. When the cloud-based object management system 116 determines (at 514) that the session identifier from the session cookie is not still valid, the method 500 proceeds to 516, where the cloud-based object management system 116 generates and sends an error message back to the browser 332 with a request that the user logs back into the cloud-based object management system 116 and successfully authenticates with the cloud-based object management system 116.

At 518, the user attempts to log into and successfully authenticate with the cloud-based object management system 116, and the method loops back to 510. This loop at 518, 510, 514, 516, 518 can repeat until the user successfully authenticates with the cloud-based object management system 116 at 518 and the cloud-based object management system 116 determines (at 514) that the session identifier from the session cookie is still valid.

When the cloud-based object management system 116 determines (at 514) that the session identifier from the session cookie is still valid, the method 500 proceeds to 520, where the cloud-based object management system 116 then uses the information from the object creation form to create the object at the cloud-based object management system 116.

At 522, the cloud-based object management system 116 communicates a response back to the object creation plugin 334 indicating that the object has been successfully created at the cloud-based object management system 116. In one embodiment, the response includes a URL for navigating to a page rendered by the application that displays the object that was created at the cloud-based object management system 116. The plugin 334 can display a message within a pop-up window indicating that the object has been created at the cloud-based object management system 116. In one embodiment, this message can include a hyperlink (or equivalent) that the user can select to load the URL into the browser and navigate to the page that displays the object that was created at the cloud-based object management system 116.

FIG. 7F is a screenshot that shows a non-limiting implementation of information that can be displayed in the object creation form within the pop-up window 720 after submission to the object management system in accordance with an embodiment. Upon receiving the response back from the 114, the object creation plugin 334 can clear certain fields of the object creation form (that are not filled with the pre-populated information) so that the object creation form is ready to use the next time the user wants to create another object, and the pop-up window 720 of the object creation plugin 334 can include a message such as object completed or object created (e.g., Work Created in FIG. 7F).

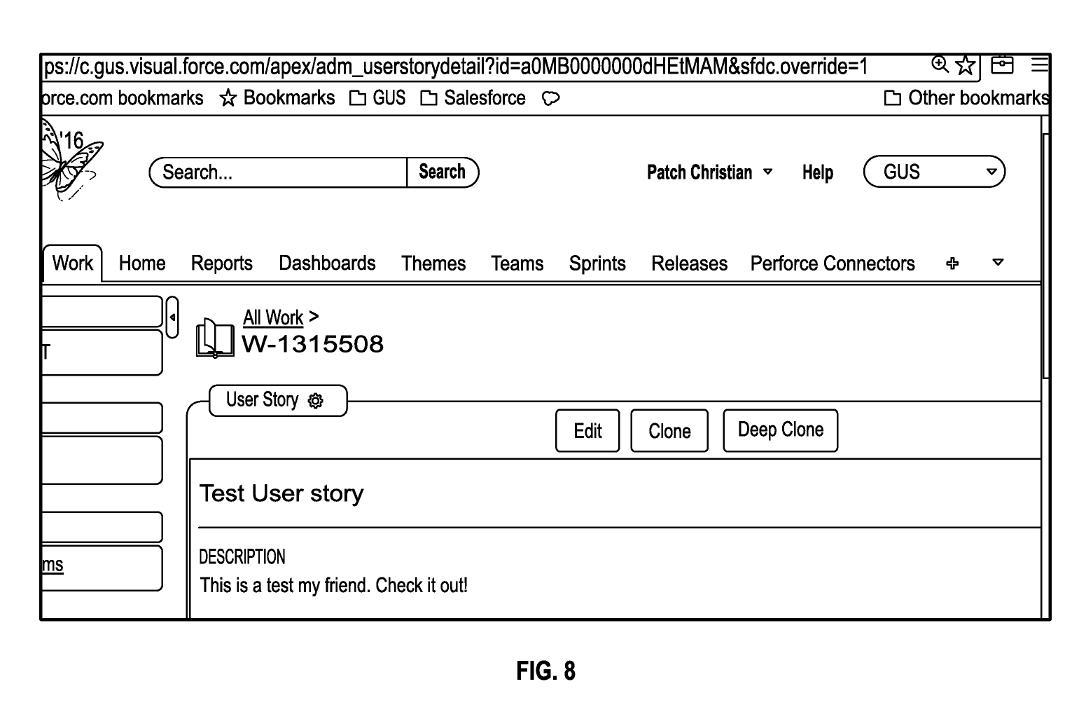

FIG. 8 is a screenshot of web page that displays the object generated by the object management system that in accordance with an embodiment. For instance, in one implementation, when the user clicks on the link labeled Work Created in FIG. 7F, this can cause the object creation plugin 334 to open a new browser window that displays a page of the cloud-based object management system 116 as shown in FIG. 8. The user can then view and interact with that object at the cloud-based object management system 116 to add additional information, edit information, delete information, etc. The user can close or minimize the object creation form (displayed in FIG. 7F) by clicking on the icon 708 for the object creation plugin 334, and can re-open it by simply clicking on the icon again to open or maximize the pop-up window that includes the object creation form. After 522, any subsequent interaction with the object creation form can effectively restart the method 500 at 506.

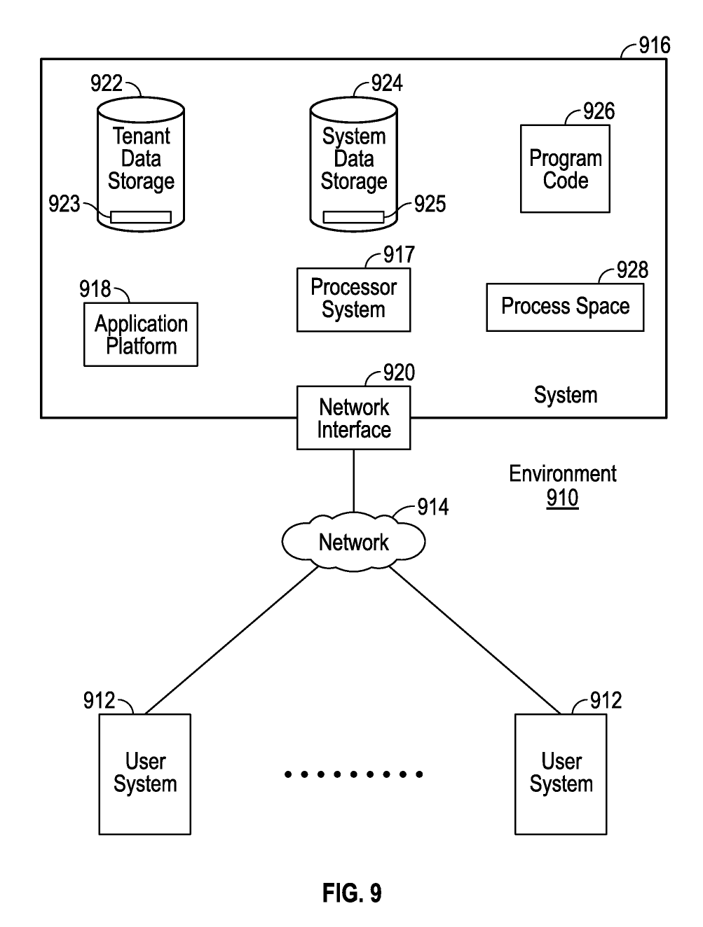

FIG. 9 illustrates a block diagram of an example environment 910 where a database service might be used, and which may be used to implement the embodiments described herein. Environment 910 may include user systems 912, network 914, system 916, processor system 917, application platform 918, network interface 920, tenant data storage 922, system data storage 924, program code 926, and process space 928. In other embodiments, environment 910 may not have all of the components listed and/or may have other elements instead of, or in addition to, those listed above.

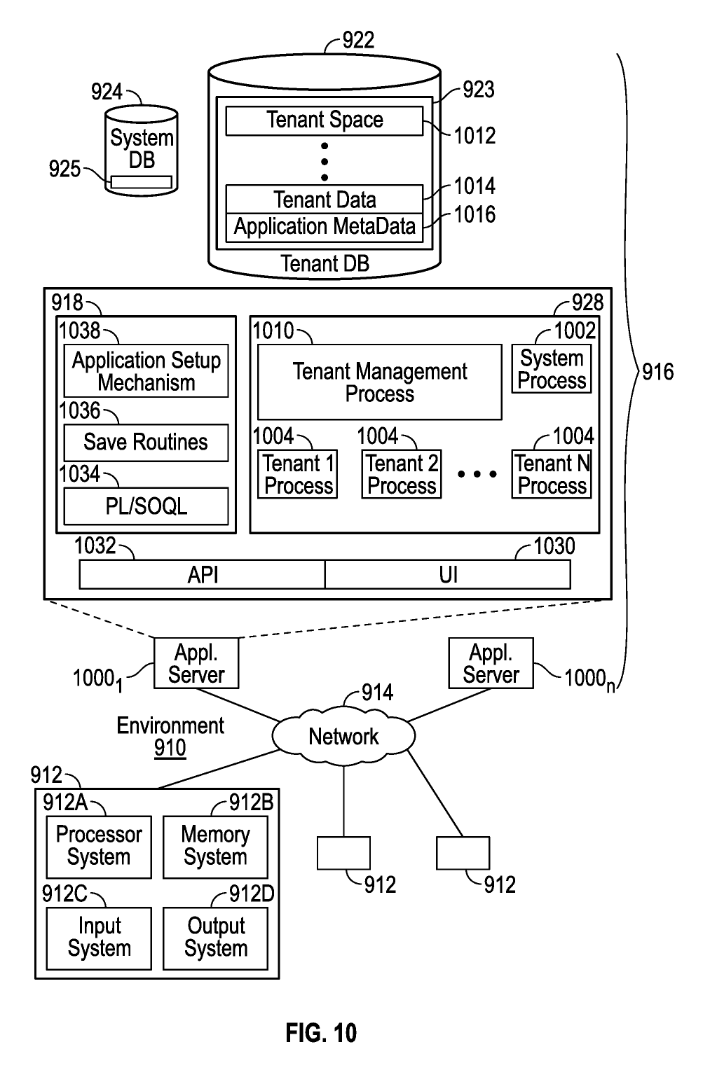

Environment 910 is an environment in which an on-demand database service exists. User system 912 may be any machine or system that is used by a user to access a database user system. For example, any of user systems 912 can be a handheld computing device, a mobile phone, a laptop computer, a work station, and/or a network of computing devices. As illustrated in FIG. 9 (and in more detail in FIG. 10) user systems 912 might interact via a network 914 with an on-demand database service, which is system 916. System 916 may also be referred to as a cloud service provider. System 916 provides its resources to customers (e.g., end users) as a service.

An on-demand database service, such as system 916, is a database system that is made available to outside users who do not need to necessarily be concerned with building and/or maintaining the database system, but instead may be available for more general use when the users need the database system (e.g., on the demand of the users). Some on-demand database services may store information from one or more tenants stored into tables of a common database image to form a multi-tenant database system (MTS). Accordingly, “on-demand database service 916” and “system 916” will be used interchangeably herein. A database image may include one or more database objects. A relational database management system (RDMS) or the equivalent may execute storage and retrieval of information against the database object(s). Application platform 918 may be a framework that allows the applications of system 916 to run, such as the hardware and/or software, e.g., the operating system. In an embodiment, system 916 may include an application platform 918 that enables creating, managing, and executing one or more applications developed for an on-demand database service, for users accessing the on-demand database service via user systems 912, or for third party application developers accessing the on-demand database service via user systems 912.

The users of user systems 912 may differ in their respective capacities, and the capacity of a particular user system 912 might be entirely determined by permissions (permission levels) for the current user. For example, where a salesperson is using a particular user system 912 to interact with system 916, that user system has the capacities allotted to that salesperson. However, while an administrator is using that user system to interact with system 916, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 914 is any network or combination of networks of devices that communicate with one another. For example, network 914 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global internetwork of networks often referred to as the “Internet” with a capital “I.” That network will be used in many of the examples herein. However, it should be understood that the networks used with the embodiment described herein use are not so limited, although TCP/IP is a frequently implemented protocol.

User systems 912 might communicate with system 916 using TCP/IP and, at a higher network level, use other common Internet protocols to communicate, such as hypertext transfer protocol (HTTP), file transfer protocol (FTP), Andrew file system (AFS), wireless application protocol (WAP), etc. In an example where HTTP is used, user system 912 might include an HTTP client commonly referred to as a “browser” for sending and receiving HTTP messages to and from an HTTP server at system 916. Such an HTTP server might be implemented as the sole network interface between system 916 and network 914, but other techniques might be used as well or instead. In some implementations, the interface between system 916 and network 914 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 916, shown in FIG. 9, implements a web-based customer relationship management (CRM) system. For example, in one embodiment, system 916 includes application servers configured to implement and execute CRM software applications as well as to provide related data, code, forms, webpages and other information to and from user systems 912. The application servers are also configured to store to, and retrieve from, a database system related data, objects, and Webpage content. With a multi-tenant system, data for multiple tenants may be stored in the same physical database object. Tenant data may be arranged such that data of one tenant is kept logically separate from that of other tenants so that one tenant does not have access to another tenant's data, unless such data is expressly shared. In certain embodiments, system 916 implements applications other than, or in addition to, a CRM application. For example, system 916 may provide tenant access to multiple hosted (standard and custom) applications, including a CRM application. User (or third party application developer) software applications, which may or may not include CRM, may be supported by the application platform 918, which manages the creation and storage of the applications into one or more database objects, and executing of the applications in a virtual machine in the process space of the system 916. The terms “application,” “software application,” “software package,” “software code,” and “program code” are used interchangeably.

One arrangement for elements of system 916 is shown in FIG. 9, including a network interface 920, application platform 918, tenant data storage 922 for tenant data 923, system data storage 924 for system data 925 accessible to system 916 and possibly multiple tenants, program code 926 for implementing various functions of system 916, and a process space 928 for executing MTS system processes and tenant-specific processes, such as running applications as part of an application hosting service. Additional processes that may execute on system 916 include database indexing processes.

Several elements in the system shown in FIG. 9 include conventional, well-known elements that are explained only briefly here. For example, each user system 912 could include a desktop personal computer, workstation, laptop, PDA, cell phone, or any wireless access protocol (WAP) enabled device or any other computing device capable of interfacing directly or indirectly to the Internet or other network connection. User system 912 typically runs an HTTP client, e.g., a browsing program, such as Google's Chrome browser, Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 912 to access, process and view information, pages and applications available to it from system 916 over network 914. Each user system 912 also typically includes one or more user interface devices, such as a keyboard, a mouse, trackball, touch pad, touch screen, pen or the like, for interacting with a graphical user interface (GUI) provided by the browser on a display (e.g., a monitor screen, liquid crystal display (LCD) monitor, etc.) in conjunction with pages, forms, applications and other information provided by system 916 or other systems or servers. For example, the user interface device can be used to access data and applications hosted by system 916, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 912 and all of its components are operator configurable using applications, such as a browser, including computer code run using a central processing unit such as an Intel Pentium® processor or the like. Similarly, system 916 (and additional instances of an MTS, where more than one is present) and all of their components might be operator configurable using application(s) including computer code to run using a central processing unit such as processor system 917, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 916 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a read-only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 916 is configured to provide webpages, forms, applications, data and media content to user (client) systems 912 to support the access by user systems 912 as tenants of system 916. As such, system 916 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., object oriented database management system (OODBMS) or rational database management system (RDBMS)) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 10 illustrates a block diagram of another example environment 910, which may be used to implement the embodiments described herein. Some of the elements in FIG. 10 overlap with those in FIG. 9, and therefore FIG. 10 will be described with reference to FIG. 9, and common numbering will be used for elements in FIG. 10 that are shown in FIG. 9. FIG. 10 also illustrates elements of system 916 and various interconnections, according to one embodiment. FIG. 10 shows that user system 912 may include processor system 912A (analogous to processing system(s) 302 in FIG. 3), memory system 912B (analogous to main memory 304 in FIG. 3), input system 912C (analogous to input system(s) 316 in FIG. 3), and output system 912D (analogous to output system(s) 318 in FIG. 3). FIG. 10 shows network 914 and system 916. FIG. 10 also shows that system 916 may include tenant data storage 922, tenant data 923, system data storage 924, system data 925, user interface (UI) 1030, application program interface (API) 1032, PL/Salesforce.com object query language (PL/SOQL) 1034, save routines 1036, application setup mechanism 1038, applications servers 1000₁-1000_{N}, system process space 1002, tenant process spaces 1004, tenant management process space 1010, tenant storage area 1012, user storage for tenant data 1014, and application metadata 1016. In other embodiments, environment 910 may not have the same elements as those listed above and/or may have other elements instead of, or in addition to, those listed above.

User system 912, network 914, system 916, tenant data storage 922, and system data storage 924 were discussed above in FIG. 9. Regarding user system 912, processor system 912A may be any combination of one or more processors. Memory system 912B may be any combination of one or more memory devices, short term, and/or long term memory. Input system 912C may be any combination of input devices, such as one or more keyboards, mice, trackballs, scanners, cameras, and/or interfaces to networks. Output system 912D may be any combination of output devices, such as one or more monitors, printers, and/or interfaces to networks. As shown in FIG. 9, system 916 may include a network interface 920 (of FIG. 9) implemented as a set of HTTP application servers 1000, an application platform 918, tenant data storage 922, and system data storage 924. Also shown is system process space 1002, including individual tenant process spaces 1004 and a tenant management process space 1010. Each application server 1000 may be configured to access tenant data storage 922 and the tenant data 923 therein, and system data storage 924 and the system data 925 therein to serve requests of user systems 912. The tenant data 923 might be divided into individual tenant storage areas 1012, which can be either a physical arrangement and/or a logical arrangement of data. Within each tenant storage area 1012, user storage 1014 and application metadata 1016 might be similarly allocated for each user. For example, a copy of a user's most recently used (MRU) items might be stored to user storage 1014. Similarly, a copy of MRU items for an entire organization that is a tenant might be stored to tenant storage area 1012. A UI 1030 provides a user interface and an API 1032 provides an application programmer interface to system 916 resident processes and to users and/or developers at user systems 912. The tenant data and the system data may be stored in various databases, such as one or more Oracle™ databases.

Application platform 918 includes an application setup mechanism 1038 that supports application developers' creation and management of applications, which may be saved as metadata into tenant data storage 922 by save routines 1036 for execution by subscribers as one or more tenant process spaces 1004 managed by tenant management process 1010, for example. Invocations to such applications may be coded using PL/SOQL 1034 that provides a programming language style interface extension to API 1032. Invocations to applications may be detected by one or more system processes, which manage retrieving application metadata 1016 for the subscriber, making the invocation and executing the metadata as an application in a virtual machine.

Each application server 1000 may be communicably coupled to database systems, e.g., having access to system data 925 and tenant data 923, via a different network connection. For example, one application server 10001 might be coupled via the network 914 (e.g., the Internet), another application server 1000N−1 might be coupled via a direct network link, and another application server 1000N might be coupled by yet a different network connection. Transfer control protocol and Internet protocol (TCP/IP) are typical protocols for communicating between application servers 1000 and the database system. However, it will be apparent to one skilled in the art that other transport protocols may be used to optimize the system depending on the network connection used.

In certain embodiments, each application server 1000 is configured to handle requests for any user associated with any organization that is a tenant. Because it is desirable to be able to add and remove application servers from the server pool at any time for any reason, there is preferably no server affinity for a user and/or organization to a specific application server 1000. In one embodiment, therefore, an interface system implementing a load balancing function (e.g., an F5 Big-IP load balancer) is communicably coupled between the application servers 1000 and the user systems 912 to distribute requests to the application servers 1000. In one embodiment, the load balancer uses a least connections algorithm to route user requests to the application servers 1000. Other examples of load balancing algorithms, such as round robin and observed response time, also can be used. For example, in certain embodiments, three consecutive requests from the same user could hit three different application servers 1000, and three requests from different users could hit the same application server 1000. In this manner, system 916 is multi-tenant, wherein system 916 handles the storage of, and access to, different objects, data and applications across disparate users and organizations.

As an example of storage, one tenant might be a company that employs a sales force where each salesperson uses system 916 to manage his or her sales process. Thus, a user might maintain contact data, leads data, customer follow-up data, performance data, goals and progress data, etc., all applicable to that user's personal sales process (e.g., in tenant data storage 922). In an example of an MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 916 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 916 might also maintain system level data usable by multiple tenants or other data. Such system level data might include industry reports, news, postings, and the like that are sharable among tenants.

In certain embodiments, user systems 912 (which may be client systems) communicate with application servers 1000 to request and update system-level and tenant-level data from system 916 that may require sending one or more queries to tenant data storage 922 and/or system data storage 924. System 916 (e.g., an application server 1000 in system 916) automatically generates one or more structured query language (SQL) statements (e.g., one or more SQL queries) that are designed to access the desired information. System data storage 924 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the embodiments described herein. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium (also referred to as a machine-readable storage medium) for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

A “processor,” “processor system,” or “processing system” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions.

For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed:

1. A system, comprising:
a cloud-based object management system, comprising: a processor system that is configured to execute an application to create objects in response to information input by a user; and
a user system, communicatively coupled to the cloud-based object management system, the user system comprising:
a processing system;
memory configured to store a browser application and a plugin that interfaces with the browser application, wherein, upon being activated and executed by the processing system, the plugin is configured to:
render, within a browser window, a set of fields that are configured to have information input that is used to create an object on the cloud-based object management system; and
provide the information that was input to the processing system for communication to the cloud-based object management system for use in creating the object.

2. The system according to claim 1, wherein the information is other information specific to the object to be created, wherein the set of fields comprises: a first set of the fields and a second set of fields, and wherein the plugin is configured to:
render, within the browser window, the first set of the fields that are pre-populated with default information used to create the object on the cloud-based object management system, and the second set of fields that are configured to have the other information input that is used along with the default information to create the object on the cloud-based object management system; and
provide the default information from the first set of fields and the other information that was input into the second set of fields to the processing system for communication to the cloud-based object management system for use in creating the object.

3. The system according to claim 2, wherein the plugin is configured via inputs from the user system comprising the default information that is used by the cloud-based object management system to create objects, wherein the plugin is configured to:
store the default information for future use and inclusion within the first set of the fields displayed in the pop-up window of the plugin whenever the plugin is activated to create objects;
display, within a browser window, a pop-up window that includes the first set of the fields pre-populated with the default information, and the second set of fields that are configured to have the other information input that is specific to the object to be created; and
receive, from the user system, inputs for the second set of fields that include the other information;
wherein an application at the cloud-based object management system is further configured to:
create the object, based on the default information and the other information, and store the object.

4. The system according to claim 3, wherein the default information is defined prior to activating the plugin so that each time the plugin is activated the default information can be used to pre-populate the first set of the fields displayed in the pop-up window to reduce amount of information the user has to input to create objects at the cloud-based object management system.

5. The system according to claim 2, wherein the browser application at the user system is configured to authenticate with the cloud-based object management system, and when the user system successfully authenticates with the cloud-based object management system, wherein the cloud-based object management system is configured to communicate a session identifier to the user system that identifies a session between the cloud-based object management system and the user system.

6. The system according to claim 5, wherein the user system is configured to communicate a request to create the object to the cloud-based object management system, wherein the request includes the session identifier, the default information and the other information, and
wherein the cloud-based object management system is configured to create the object, based on the default information and the other information submitted by the user system, when the cloud-based object management system determines that the session identifier is still valid without requiring a user of the user system to manually enter information to login to the cloud-based object management system.

7. The system according to claim 2, wherein the plugin is further configured to:
present a dialog box within a browser window that comprises a plurality of user input fields, wherein the user system is configured to input the default information into the user input fields, wherein the default information is reoccurring information that is consistently the same in various objects created at the cloud-based object management system.

8. The system according to claim 2, wherein the cloud-based object management system is configured to:
create the object based on the default information and the other information, and communicate a response back to the plugin indicating that the object was successfully created and that includes a URL for navigating to a page rendered by the application that displays the object that was created at the cloud-based object management system; and
wherein the plugin is further configured to:
display a message within a pop-up window indicating that the object has been created, wherein the message includes a hyperlink that a user can select to load the URL and navigate to the page.

9. A method comprising:
activating, at a user system, a plugin that interfaces with a browser application and that is used to create objects at a cloud-based object management system;
inputting, via the plugin, information that is used along to create an object;
submitting the information to the cloud-based object management system; and
creating, based on the information, the object on the cloud-based object management system.

10. The method according to claim 9, wherein the information comprises other information that is specific to the object to be created, and further comprising:
configuring, via a user system, a plugin that interfaces with a browser application by inputting default information that is used to create objects at a cloud-based object management system;
wherein inputting comprises:
inputting, via the plugin, other information that is used along with the default information to create the object;
wherein submitting comprises:
submitting the default information and the other information to the cloud-based object management system; and
wherein creating comprises:
creating, based on the default information and the other information, the object on the cloud-based object management system

11. The method according to claim 10, further comprising:
displaying, in response to activating the plugin, a pop-up window within a browser window, wherein the pop-up window displays a first set of the fields are pre-populated with the default information used to create the object, and a second set of fields that are configured to have the other information input that is used to create the object; and
wherein inputting comprises:
inputting, via the plugin, the other information into the second set of fields, wherein the other information is used along with the default information to create an object.

12. The method according to claim 11, wherein the default information is defined prior to activating the plugin so that each time the plugin is activated the default information can be used to pre-populate the first set of the fields displayed in the pop-up window of the plugin to reduce an amount of information the user has to input to create objects at the cloud-based object management system.

13. The method according to claim 11, wherein configuring further comprises:
storing the default information for future use and inclusion within the first set of the fields displayed in the pop-up window of the plugin whenever the plugin is activated to create objects.

14. The method according to claim 10, further comprising:
prior to activating, authenticating the user system with the cloud-based object management system, wherein authenticating comprises:
communicating, from the cloud-based object management system to the user system when the user system successfully authenticates with the cloud-based object management system, a session identifier that identifies a session between the cloud-based object management system and the user system.

15. The method according to claim 14, wherein submitting further comprises:
communicating a request to create the object from the user system to the cloud-based object management system, wherein the request includes the session identifier, the default information and the other information; and
when the cloud-based object management system determines that the session identifier is still valid: accepting the default information and the other information submitted by the user system at the cloud-based object management system for creation of the object.

16. The method according to claim 15, wherein the object is created at the cloud-based object management system, based on the default information and the other information, without requiring a user of the user system to manually enter information to login to the cloud-based object management system when the session identifier is determined to be valid by the cloud-based object management system.

17. The method according to claim 10, wherein configuring further comprises:
presenting, at the user system, a dialog box that comprises a plurality of user input fields, wherein at least some of the user input fields are configured to receive the default information input by a user of the user system; and
inputting the default information that is used to create objects into the user input fields.

18. The method according to claim 17, wherein the default information that is input into the user input fields is reoccurring information that is consistently the same in various objects that the user of the user system creates at the cloud-based object management system.

19. The method according to claim 9, further comprising:
communicating, from the cloud-based object management system, a response back to the plugin indicating that the object was successfully created at the cloud-based object management system, wherein the response includes a URL for navigating to a page rendered by the application that displays the object that was created at the cloud-based object management system;
displaying, via the plugin, a message within a pop-up window indicating that the object has been created at the cloud-based object management system,
wherein the message includes a hyperlink that a user can select to load the URL and navigate to the page.

20. A computer program product, comprising:
a non-transitory computer readable medium having a computer readable program code embodied therein that is readable by a processing circuit and storing instructions for execution by the processing circuit to perform a method, the method comprising:
storing a session cookie that comprises a session identifier that establishes successful authentication between an application at a cloud-based object management system and a browser at a user system, wherein the session identifier can be used to identify a session between the application and the user system;
displaying, within a browser window, a pop-up window that includes a set of fields that are configured to have information input that is used to create an object;
receiving, from the user system, the information that is input into the set of fields; and
communicating a request to an application at the cloud-based object management system to create the object, wherein the request includes the session identifier and the information to be used by the application to create the object when the session identifier is determined to still be valid.
